(19) United States
(12) Patent Application Publication
(10) Pub. No.: US 2024/0281306 A1
(43) Pub. Date: Aug. 22, 2024

(54) COMMON FILE ATTRIBUTE PROCESSING FOR ENHANCED LOADING TIME OF APPLICATION PROGRAMMING INTERFACE (API) FILES

(71) Applicant: Rakuten Symphony Singapore Pte. Ltd., Singapore (SG)

(72) Inventors: Manoj ASWANI, Indore (IN); Hemant SHARMA, Indore (IN); Ayus KUMAR, Indore (IN); Satyam GUPTA, Indore (IN); Pratham JAIN, Indore (IN)

(21) Appl. No.: 18/043,042

(22) PCT Filed: Oct. 18, 2022
(86) PCT No.: PCT/US2022/046963

§ 371 Date: Feb. 27, 2023

(51) Int. Cl. G06F 9/54

(52) U.S. Cl. CPC G06F 9/54

(57) ABSTRACT

Common file attribute processing is used for providing enhanced loading time of Application Programming Interface (API) files. An Extensible Markup Language (XML) file of an API is parsed. XML element objects in XML file are parsed. Whether there is at least one common attribute for the XML element objects is determined. In response to determining there is at least one common attribute for the XML element objects, attribute data for the at least one common attribute is retrieved from storage and the attribute data is added in an API resource object.

### TECHNICAL FIELD

This description relates to a system, method, and non-transitory computer-readable media providing common file attribute processing for enhanced loading time of Application Programming Interface (API) files.

### BACKGROUND

An Application Programming Interface (API) is a set of definitions and protocols for building and integrating application software. Swagger files are used to provide a description for REST APIs (also known as RESTful APIs). REST stands for representational state transfer. A RESTful API transfers a representation of the state of the resource to the requester or endpoint. The swagger file provides a resource listing of an API and includes information describing the operations that the API supports, the API's parameters, what type of returns are provided, whether the API uses authorization for access, etc.

As API files increase in size, the load time for the API files increases. With very large API files, the load time and the time to start becomes very long. During loading of an xml swagger file, the attributes are read by the services every time, which is not required for runtime loading.

When the API is updated or changes are made, reloading of the API to an API Gateway at startup time results in a long time where the system is unavailable. Even when a change is made that affects a subset of the attributes of the API file, all attributes are read and new attribute objects are created for every attribute. The long load times begin to affect the readiness of the system where zero downtime is the goal.

### SUMMARY

In at least embodiment, a method for providing common file attribute processing for enhanced loading time of Application Programming Interface (API) files includes receiving an Extensible Markup Language (XML) file of an API, parsing the XML file, processing XML element objects in the XML file, determining whether there is at least one common attribute for the XML element objects, and in response to determining there is at least one common attribute for the XML element objects, retrieving data for the at least one common attribute from storage and add attribute data in an API resource object.

In at least embodiment, an Application Programming Interface (API) gateway includes a memory storing computer-readable instructions, and a processor connected to the memory, wherein the processor is configured to execute the computer-readable instructions to
receive an Extensible Markup Language (XML) file of an API, parse the XML file, process XML element objects in the XML file, determine whether there is at least one common attribute for the XML element objects, and in response to determining there is at least one common attribute for the XML element objects, retrieve data for the at least one common attribute from storage and add attribute data in an API resource object.

In at least embodiment, a non-transitory computer-readable media having computer-readable instructions stored thereon, which when executed by a processor causes the processor to perform operations including receiving an Extensible Markup Language (XML) file of an API, parsing the XML file, processing XML element objects in the XML file, determining whether there is at least one common attribute for the XML element objects, and in response to determining there is at least one common attribute for the XML element objects, retrieving data for the at least one common attribute from storage and add attribute data in an API resource object.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates loading of an API file.

FIG. 2 is a flowchart of a method for processing an Extensible Markup Language (XML) file of an API resulting in long load times.

FIG. 3 illustrates a processing of resources objects to sequence objects resulting in long load times.

FIG. 4 is a flowchart of a method for processing an XML file of an API resulting in reduced load times according to at least one embodiment.

FIG. 5 illustrates mapping of resources objects to sequence objects that provides enhanced loading time of API files according to at least one embodiment.

FIG. 6 illustrates an example XML API file having attributes that have already been processed according to at least one embodiment.

FIG. 7 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

Terms “system” and “network” in embodiments of this application are used interchangeably. “At least one” means one or more, and “a plurality of” means two or more. The term “and/or” describes an association relationship between associated objects and indicates that three relationships exist. For example, A and/or B indicate the following cases: Only A exists, both A and B exist, and only B exists, where A and B is singular or plural. The character “/” generally indicates an “or” relationship between the associated objects. “At least one of” or a similar expression thereof means any combination of items, including any combination of singular items (pieces) or plural items (pieces). For example, “at least one of A, B, and C” includes A, B, C, AB, AC, BC, or ABC, and “at least one of A, B, or C” includes A, B, C, A and B, A and C, B and C, or A and B and C.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming data-stream or signaling-stream. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming data-stream or signaling-stream, from UE.

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Embodiments described herein provide common file attribute processing for providing enhanced loading time of Application Programming Interface (API) files that includes receiving an Extensible Markup Language (XML) file of an API, parsing the XML file, processing XML element objects in the XML file, determining whether there is at least one common attribute for the XML element objects, and in response to determining there is at least one common attribute for the XML element objects, retrieving data for the at least one common attribute from storage and add attribute data in an API resource object.

Advantages include reducing the time of loading APIs because the creation of new attribute objects for common attributes is skipped. An API Gateway loads XML API files by processing common file attributes one time to create a common reference object attribute. For example, in response to a file having thousands of common attributes, then the API Gateway processes the common attributes one time to create a resource object, unless a change is made the affects that attribute. Processing the common attributes one time reduces the size of heap memory and the time of processing. By avoiding the processing of common attributes over and over, the system will be ready for use in less time.

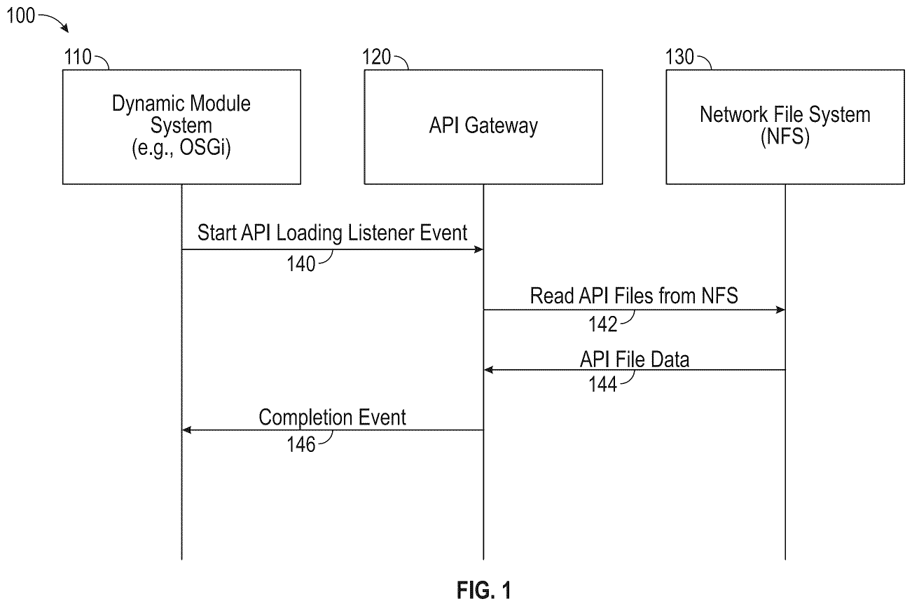

FIG. 1 illustrates loading of an API file 100.

In FIG. 1, A Dynamic Module System 110 is used for loading API files at an API Gateway 120. Dynamic Module System 110 provides a framework that allows API files to be deployed as independent modules during runtime. Such systems are “dynamic” in that API files may be uploaded to the API Gateway 120 independently of other components. OSGi is one example of a Dynamic Module System 110 for building modular, service-oriented Java™ applications. OSGi provides a service registry where developers can register and unregister services.

In FIG. 1, OSGI Service 110 triggered an API Loading Listener Event 140 for loading API files to API Gateway 120.

API Gateway 120 reads API files 142 from Network File Server (NFS) 130. The API file data is provided 144 to API Gateway 120. API Gateway 120 processes the API file. However, as API files increase in size, the load time for the API files increases. With very large API files, the load time and the time to start becomes very long. During loading, API Gateway 120 reads all the attributes, which is not required for runtime loading.

When the API is updated or changes are made, reloading of the API to API Gateway 120 at startup time results in a long time where the system is unavailable. Even when a change is made that affects a subset of the attributes of the API file, the API Gateway 120 reads all attributes and creates new attribute objects for every attribute. The long load times begin to affect the readiness of the system where zero downtime is the goal.

After Completion of API loading by the API Gateway 120, the API Gateway 120 sends the OSGi Service 110 a Completion Event 146 to notify the OSGI Service of completion of loading the API file.

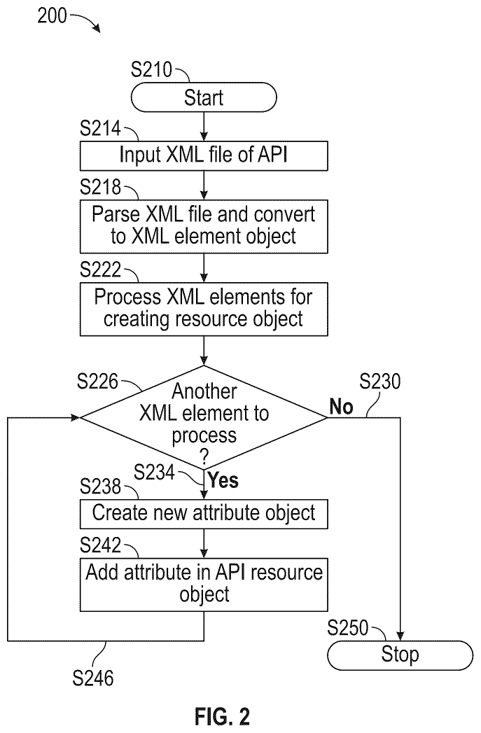

FIG. 2 is a flowchart 200 of a method for processing an Extensible Markup Language (XML) file of an API resulting in long load times.

In FIG. 2, the uploading process starts S210 and an XML file of the API is input S214. The XML file is parsed and attributes are converted to XML Element Objects S218. The XML Elements are processed to create resource objects S222. A decision is made whether there is another XML element to process S226. In response to there not being another XML element to process S230, the method stops S250. In response to there being another XML element to process S234, the new attribute object is created S238. The new attribute is added in the API resource object S420. The method loops back S246 to determine whether there is another XML element to process S226.

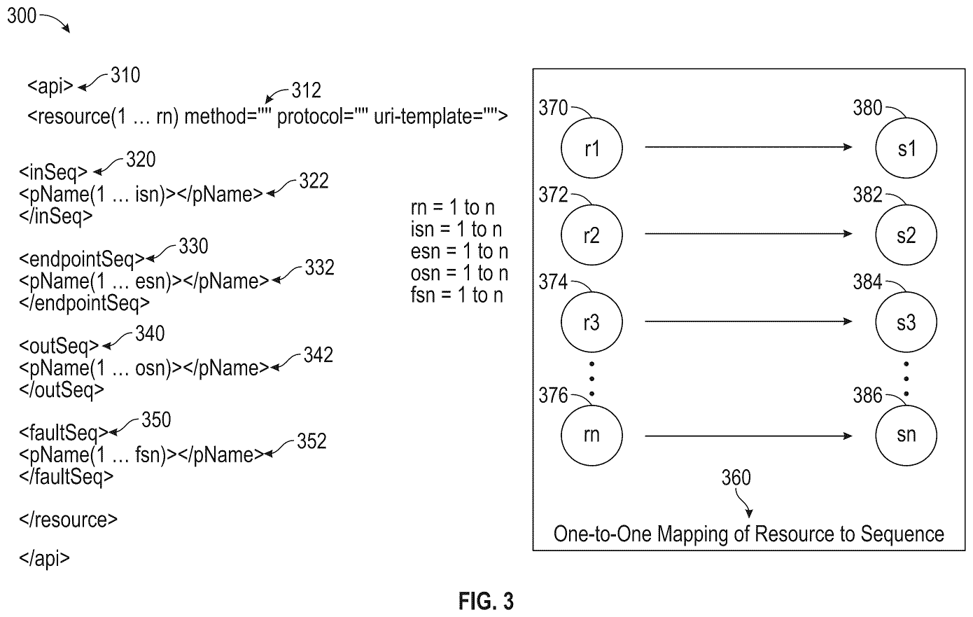

FIG. 3 illustrates a processing of resources objects to sequence objects 300 resulting in long load times.

In FIG. 3, an example of an XML file sets the resource method 310. Resource Nodes (rn) range from 1 to n 312. An “inSeq” (or “in-sequence”) 320 handles the incoming requests sent by the client. “In-sequence Nodes” (isn) range from 1 to n 322. Mediated messages are then forwarded to the target endpoint which generally points to the real back-end service. The “endpointSeq” (or “endpoint sequence”) 330 defines the data sources. The “Endpoint Sequence Nodes” (esn) also range from 1 to n 332. The “outSeq” (or “out-sequence”) 340 processes responses coming back from a back-end service. “Out-sequence Nodes” (osn) range from 1 to n 342. In addition to these, a “faultSeq” (or “fault sequence”) 350 is invoked in case of an error. “Fault Sequence Nodes” (fsn) range from 1 to n 352.

Long load times result from one-to-one mapping of resource objects to common sequence objects nodes 360. Resource Objects, r1 370, r2 372, r3 374, rn 376, are shown mapped with common Sequence Objects, s1 380, s2 382, s3 384, sn 386, respectively, in a one-to-one manner.

The one-to-one mapping of Resource Objects, r1 370, r2 372, r3 374, rn 376, to Sequence Objects, s1 380, s2 382, s3 384, sn 386, respectively, indicates that new attribute objects are created for every attribute. This results in long load times that begin to affect the readiness of the system.

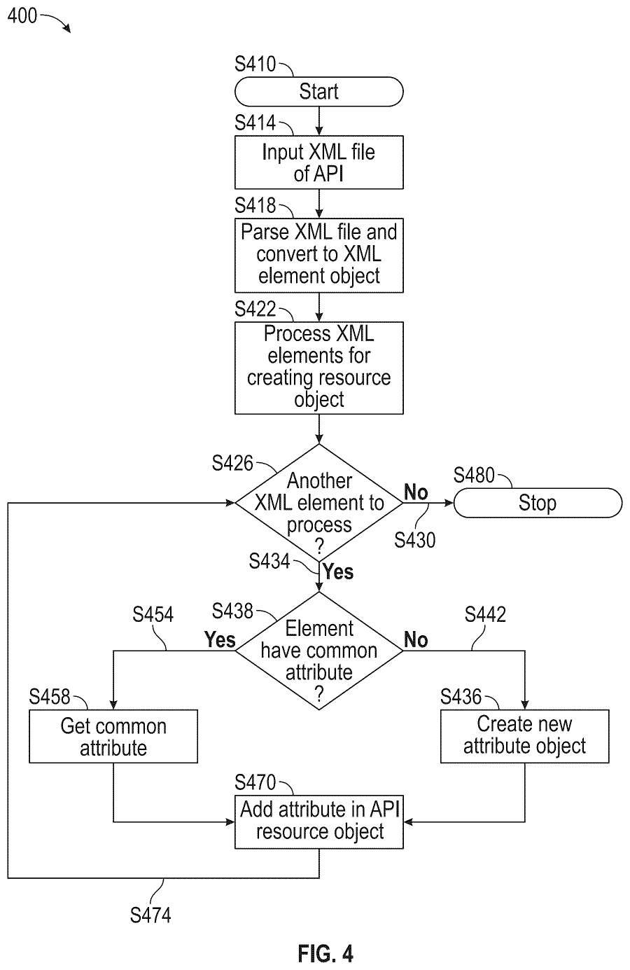

FIG. 4 is a flowchart 400 of a method for processing an XML file of an API resulting in reduced load times according to at least one embodiment.

In FIG. 4, the uploading process starts S410 and an XML file of the API is input S414. The XML file is parsed and attributes are converted to XML Element Objects S418. The XML Elements are processed to create resource objects S422. A decision is made whether there is another XML element to process S426. In response to there not being another XML element to process S430, the method stops S480.

In response to there being another XML element to process S434, a decision is made whether the elements include common attributes S438.

In response to the elements not including common attributes S442, a new attribute object is created S346. The attribute is added in the API resource object S470 and the process loops S474 to determine whether there is another XML element to process S426.

In response to the elements including common attributes S454, The common attribute is retrieved S458. Thus, the creation of new attribute objects for common attributes is skipped and the time of loading APIs is reduced. By avoiding the processing of common attributes over and over, the system will be ready for use in less time. The retrieved attribute is added in the API resource object S470 and the process loops S474 to determine whether there is another XML element to process S426.

By way of example, an API file includes 10,000 attributes and the load time for processing the 10,000 attributes takes 30 minutes. In this example, a linear relationship is used so that 10,000 attributes are processed in 30 minutes (or 1800 seconds), which equals 5.55 attributes per second being processed. Those skilled in the art understand that the time for processing possibly differs among attributes and that additional factors, including the time to retrieve data for common attributes, are able to influence the time of processing the attributes. According to these constraints, in response to 1% of the attributes representing a change that results in processing of 100 attributes, the load time is reduce to 18 seconds.

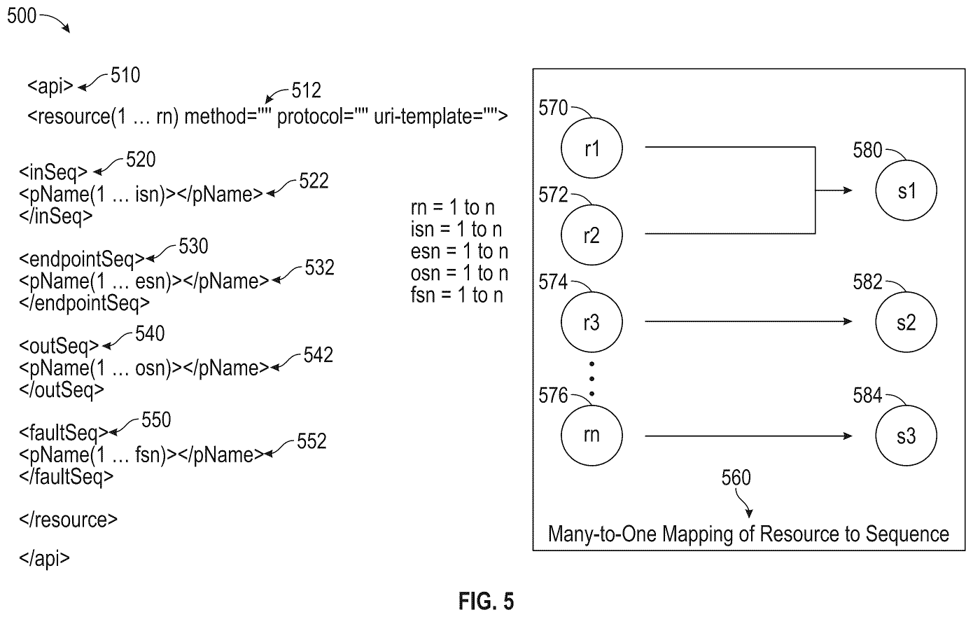

FIG. 5 illustrates mapping of resources objects to sequence objects 500 that provides enhanced loading time of API files according to at least one embodiment.

In FIG. 5, a simplified XML file is again shown where the XML file sets the resource method 510. Resource Nodes (rn) range from 1 to n 512. An “inSeq” (or “in-sequence”) 520 handles the incoming requests sent by the client. “In-sequence Nodes” (isn) range from 1 to n 522.

Mediated messages are then forwarded to the target endpoint which generally points to the real back-end service. The “endpointSeq” (or “endpoint sequence”) 530 defines the data sources. The “Endpoint Sequence Nodes” (esn) also range from 1 to n 532. The “outSeq” (or “out-sequence”) 540 processes responses coming back from a back-end service. “Out-sequence Nodes” (osn) range from 1 to n 542. In addition to these, a “faultSeq” (or “fault sequence”) 550 is invoked in case of an error. “Fault Sequence Nodes” (fsn) range from 1 to n 552.

As shown in FIG. 3, long load times result from one-to-one mapping of resource objects to common sequence objects nodes. However, FIG. 5 shows a many-to-one mapping of resource objects to sequence objects 560. The many-to-one mapping 560 indicates that the creation of new attribute objects for common attributes is skipped thereby reducing the time of loading APIs. The system becomes ready for use in less time by avoiding the processing of common attributes over and over.

In FIG. 5, Resource Objects, r1 570, r2 572, r3 574, rn 576, are shown. A first Resource Object, r1 570, is mapped with a first Sequence Object, s1 580. Second Resource Object, r2 572, is also mapped with first Sequence Object, s1 580. This represents, for example, second Resource Object, r2 572, having a common attribute that allows the processing of second Resource Object, r2 572, to be combined in-sequence with first Resource Object, r1 570. Third Resource Object, r3 is mapped with second Sequence Object, s2 582. The nth Resource Object, rn 576, is mapped with third Sequence Object, s3 584.

Thus, the creation of new attribute objects for common attributes is skipped thereby reducing the time of loading APIs. The system becomes ready for use in less time by avoiding the processing of common attributes over and over.

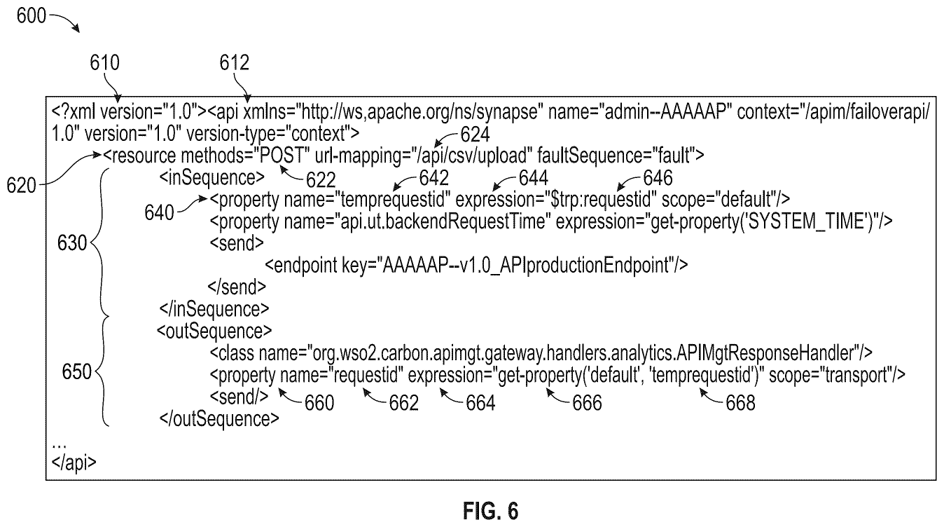

FIG. 6 illustrates an example XML API file 600 having attributes that have already been processed according to at least one embodiment.

In FIG. 6, declaration node (node_declaration) 610 represents document declarations in XML. Declaration node 610 has a name (“xml”), one or more attributes and values, e.g., attribute with name “version” and value “1.0”. The api:xmlns attribute 612 specifies the API xml namespace. XML namespaces are used for providing uniquely named elements and attributes in an XML document.

Resource methods 620 are used to perform certain operations. The four most common methods are GET, PUT, DELETE, and POST. Here, the resource method 620 is “POST” 622. POST 622 is used to create a new resource into the collection of resources. URLs 624 are used to specify the location of a resource. A PUT method is used to update an existing resource. In response to the resource not existing, then a new resource is able to be created.

In “inSequence” 630 and “outSequence” 650 there is a common resource in property name 640 and property name 660. In response to “inSequence” 630 and “outSequence” 650 tags being parsed, common attributes that have already processed are skipped. Thus, in response to the tags having the common attributes, the processing time for loading and converting the attributes is skipped and the overall load time is reduced.

Common attribute means the “in-sequence” and “out sequency” attributes are the same. Thus, for XML API file 600, property, e.g., “temprequestid” 642, 668, in the “inSequence” 630 and in the “outSequence” 650 are the same.

In response to properties not being common, object, e.g., “inSequence” object 630 and “outSequence” object 650 will be created. The created object is stored in memory and is already available at the time of reloading the XML API file.

With thousands of objects for a resource, e.g., “inSequence” 630 and “outSequence” 650, a large amount of memory and time for the processing is used. So by not processing common objects again, the time of processing is reduced. During parsing of the properties, such as the property name, “requestid” 646, 662 is the same for the other resources, and the original resource already exist. An attribute is processed one time to create a resource object unless a change is made the affects that attribute.

XML API file 600 includes “inSequence” object 630 and “outSequence” object 650. The “inSequence” object 630 handles the incoming requests sent by the client. Mediated messages are then forwarded to the target endpoint which generally points to the real back-end service. The “outSequence” object 650 handles responses coming back from a back-end service. In addition to these. a “fault sequence” can also be associated with a proxy service which is invoked in case of an error.

The “inSequence” object 630 includes “property name” object 640 with “tempreqestid” attribute 642. Attribute “temprequestid” 642 is the name of the property for this element, and expression object 644 has “$trp:requestid” attribute 646, which gives the value of the “requestid” transport header.

The “outSequence” object 650 includes “property name” object 660 with “requestid” attribute 662. Attribute “requestid” 642 is the name of the property for this element, and expression object 664 has “get-property” element 666 with two attributes “default” and “temprequestid”668.

Referring again to FIG. 1, Dynamic Module System 110 is used for loading API files at an API Gateway 120. Dynamic Module System 110 provides a framework that allows API files to be deployed as independent modules during runtime. Such systems are “dynamic” in that API files may be uploaded to the API Gateway 120 independently of other components. OSGi is one example of a Dynamic Module System 110 for building modular, service-oriented Java™ applications. OSGi provides a service registry where developers can register and unregister services.

In FIG. 1, Dynamic Module System 110 triggers an API Loading Listener Event 140 for loading API files to API Gateway 120. API Gateway 120 reads API files 142 from Network File Server (NFS) 130. The API file data is provided 144 to API Gateway 120. API Gateway 120 processes the API file. As described earlier, as API files increase in size, the load time for the API files increases. With very large API files, the load time and the time to start becomes very long.

During loading, API Gateway 120 executes the common file attribute processing for enhanced loading time of API files according to at least one embodiment. In response to the API being updated or changed, reloading of the API to API Gateway 120 at startup time results in a long time where the system is unavailable. By executing the common file attribute processing for enhanced loading time of API files according to at least one embodiment, the API Gateway 120 does not read all attributes and thus does not create a new attribute objects for every attribute.

In response to the elements including common attributes, the common attribute is retrieved and the creation of new attribute objects for common attributes is skipped thereby reducing the time of loading APIs. By avoiding the processing of common attributes over and over, the system will be ready for use in less time. The retrieved attribute is added in the API resource object and the common file attribute processing continues. After Completion of API loading by the API Gateway 120, the API Gateway 120 sends the Dynamic Module System 110 a Completion Event 146 to notify the Dynamic Module System 110 of completion of loading the API file.

In at least one embodiment, common file attribute processing for providing enhanced loading time of Application Programming Interface (API) files includes receiving an XML file of an API, parsing the XML file, processing XML element objects in the XML file, determining whether there is at least one common attribute for the XML element objects, and in response to determining there is at least one common attribute for the XML element objects, retrieving data for the at least one common attribute from storage and add attribute data in an API resource object.

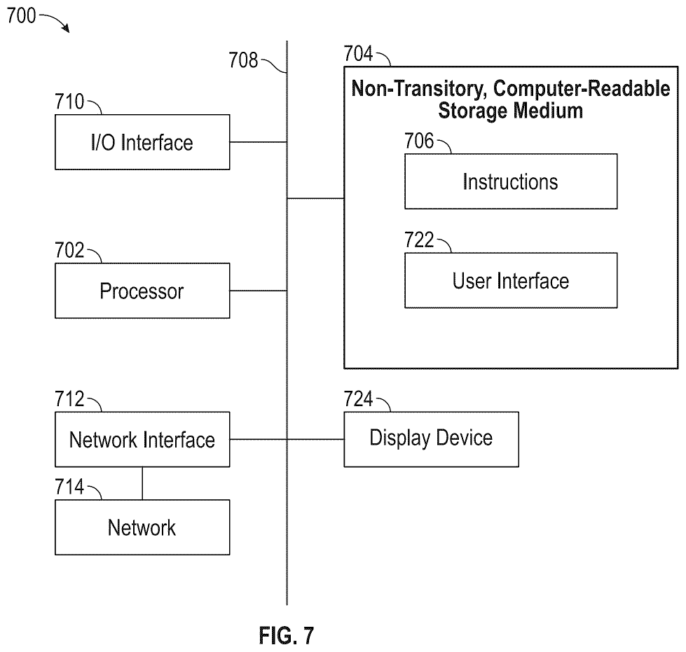

FIG. 7 is a high-level functional block diagram of a processor-based system 700 according to at least one embodiment.

In at least one embodiment, processing circuitry 700 provides end-to-end application onboarding. Processing circuitry 700 implements the common file attribute processing for enhanced loading time of API files according to at least one embodiment using processor 702. Processing circuitry 700 also includes a non-transitory, computer-readable storage medium 704 that is used to implement the common file attribute processing for enhanced loading time of API files according to at least one embodiment. Storage medium 704, amongst other things, is encoded with, i.e., stores, instructions 706, i.e., computer program code that are executed by processor 702 causes processor 702 to perform operations for the common file attribute processing for enhanced loading time of API files according to at least one embodiment. Execution of instructions 706 by processor 702 represents (at least in part) an application which implements at least a portion of the methods described herein in accordance with one or more embodiments (hereinafter, the noted processes and/or methods).

Processor 702 is electrically coupled to computer-readable storage medium 704 via a bus 708. Processor 702 is electrically coupled to an Input/output (I/O) interface 710 by bus 708. A network interface 712 is also electrically connected to processor 702 via bus 708. Network interface 712 is connected to a network 714, so that processor 702 and computer-readable storage medium 704 connect to external elements via network 714.

Processor 702 is configured to execute instructions 706 encoded in computer-readable storage medium 704 to cause processing circuitry 700 to be usable for performing at least a portion of the processes and/or methods. In one or more embodiments, processor 702 is a Central Processing Unit (CPU), a multi-processor, a distributed processing system, an Application Specific Integrated Circuit (ASIC), and/or a suitable processing unit.

Processing circuitry 700 includes I/O interface 710. I/O interface 710 is coupled to external circuitry. In one or more embodiments, I/O interface 710 includes a keyboard, keypad, mouse, trackball, trackpad, touchscreen, and/or cursor direction keys for communicating information and commands to processor 702.

Processing circuitry 700 also includes network interface 712 coupled to processor 702. Network interface 712 allows processing circuitry 700 to communicate with network 714, to which one or more other computer systems are connected. Network interface 712 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 764.

Processing circuitry 700 is configured to receive information through I/O interface 710. The information received through I/O interface 710 includes one or more of instructions, data, design rules, libraries of cells, and/or other parameters for processing by processor 702. The information is transferred to processor 702 via bus 708. Processing circuitry 700 is configured to receive information related to a User Interface (UI) 722 through I/O interface 710. The information is stored in computer-readable medium 704 as UI 722.

In one or more embodiments, one or more non-transitory computer-readable storage media 704 having stored thereon instructions (in compressed or uncompressed form) that may be used to program a computer, processor, or other electronic device) to perform processes or methods described herein. The one or more non-transitory computer-readable storage media 704 include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 704 includes a Compact Disk-Read Only Memory (CD-ROM), a Compact Disk-Read/Write (CD-R/W), and/or a Digital Video Disc (DVD).

In one or more embodiments, storage medium 704 stores computer program code 706 configured to cause processing circuitry 700 to perform at least a portion of the processes and/or methods for implementing the common file attribute processing for enhanced loading time of API files according to at least one embodiment.

In one or more embodiments, storage medium 704 also stores information, such as algorithm which facilitates performing at least a portion of the processes and/or methods for implementing the common file attribute processing for enhanced loading time of API files according to at least one embodiment.

In at least one embodiment, the processor circuitry 700 performs a method for implementing the common file attribute processing for enhanced loading time of API files according to at least one embodiment. The process of providing common file attribute processing for providing enhanced loading time of Application Programming Interface (API) files includes receiving an Extensible Markup Language (XML) file of an API, parsing the XML file, processing XML element objects in the XML file, determining whether there is at least one common attribute for the XML element objects, and in response to determining there is at least one common attribute for the XML element objects, retrieving data for the at least one common attribute from storage and add attribute data in an API resource object.

The common file attribute processing for enhanced loading time of API files according to at least one embodiment reduces the time of loading APIs because the creation of new attribute objects for common attributes is skipped. By avoiding the processing of common attributes over and over, the system will be ready for use in less time . . . . Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method providing common file attribute processing for enhanced loading time of Application Programming Interface (API) files, comprising:
receiving an Extensible Markup Language (XML) file of an API;
parsing the XML file;
processing XML element objects in the XML file;
determining whether there is at least one common attribute for the XML element objects; and
in response to determining there is at least one common attribute for the XML element objects, retrieving data for the at least one common attribute from storage and add attribute data in an API resource object.

2. The method of claim 1 further comprising continuing to determine whether there is at least one common attribute for the XML element objects until there are no more XML element objects to process.

3. The method of claim 1, wherein the determining whether the at least one common attribute for the XML element objects includes:
identifying attributes in in-sequence elements;
identifying attributes in out-sequence elements;
determining whether one of the attributes in the in-sequence elements match at least one of the attributes in the out-sequence elements; and
in response to the one of the attributes in the in-sequence elements matching the at least one of the attributes in the out-sequence elements, identifying the one of the attributes in the in-sequence elements matching the at least one of the attributes in the out-sequence elements as the at least one common attribute.

4. The method of claim 1, wherein the processing the XML element objects in XML file includes determining there are no more XML element objects to parse in the XML file and stopping the process.

5. The method of claim 1, wherein the determining whether there is the at least one common attribute for the XML element objects includes creating a many-to-one mapping between resource objects and sequence objects.

6. The method of claim 1, in response to the XML element not having the at least one common attribute, creating a new attribute object and adding attribute data in API resource object.

7. The method of claim 6, wherein the determining whether there is not the at least one common attribute for the XML element objects includes creating a one-to-one mapping between resource objects and sequence objects.

8. An Application Programming Interface (API) gateway, comprising:
a memory storing computer-readable instructions; and
a processor connected to the memory, wherein the processor is configured to execute the computer-readable instructions to:
receive an Extensible Markup Language (XML) file of an API;
parse the XML file;
process XML element objects in the XML file;
determine whether there is at least one common attribute for the XML element objects; and
in response to determining there is at least one common attribute for the XML element objects, retrieve data for the at least one common attribute from storage and add attribute data in an API resource object.

9. The API gateway of claim 8, wherein the processor is further configured to continue determining whether there is at least one common attribute for the XML element objects until the processor determines there are no more XML element objects to process.

10. The API gateway of claim 8, wherein the processor determines whether the at least one common attribute for the XML element objects by:
identifying attributes in in-sequence elements;
identifying attributes in out-sequence elements;
determining whether one of the attributes in the in-sequence elements match at least one of the attributes in the out-sequence elements; and
in response to the one of the attributes in the in-sequence elements matching the at least one of the attributes in the out-sequence elements, identifying the one of the attributes in the in-sequence elements matching the at least one of the attributes in the out-sequence elements as the at least one common attribute.

11. The API gateway of claim 8, wherein the processor is further configured to process the XML element objects in XML file by determining there are no more XML element objects to parse in the XML file and stopping the process.

12. The API gateway of claim 8, wherein the processor, in response to determining whether there is the at least one common attribute for the XML element objects, creates a many-to-one mapping between resource objects and sequence objects.

13. The API gateway of claim 8, wherein the processor, in response to the XML element not having the at least one common attribute, creates a new attribute object and adds attribute data in API resource object.

14. The API gateway of claim 13, wherein the processor is further configured to create a one-to-one mapping between resource objects and sequence objects.

15. A non-transitory computer-readable media having computer-readable instructions stored thereon, which when executed by a processor causes the processor to perform operations comprising:
receiving an Extensible Markup Language (XML) file of an Application Programming Interface (API);
parsing the XML file;
processing XML element objects in the XML file;
determining whether there is at least one common attribute for the XML element objects; and
in response to determining there is at least one common attribute for the XML element objects, retrieving data for the at least one common attribute from storage and add attribute data in an API resource object.

16. The non-transitory computer-readable media of claim 15 further comprising continuing to determine whether there is at least one common attribute for the XML element objects until there are no more XML element objects to process.

17. The non-transitory computer-readable media of claim 15, wherein the determining whether the at least one common attribute for the XML element objects includes:
identifying attributes in in-sequence elements;
identifying attributes in out-sequence elements;
determining whether one of the attributes in the in-sequence elements match at least one of the attributes in the out-sequence elements; and
in response to the one of the attributes in the in-sequence elements matching the at least one of the attributes in the out-sequence elements, identifying the one of the attributes in the in-sequence elements matching the at least one of the attributes in the out-sequence elements as the at least one common attribute.

18. The non-transitory computer-readable media of claim 15, wherein the processing the XML element objects in XML file includes determining there are no more XML element objects to parse in the XML file and stopping the process.

19. The non-transitory computer-readable media of claim 15, wherein the determining whether there is the at least one common attribute for the XML element objects includes creating a many-to-one mapping between resource objects and sequence objects.

20. The non-transitory computer-readable media of claim 15, in response to the XML element not having the at least one common attribute, creating a new attribute object and adding attribute data in API resource object, and creating a one-to-one mapping between resource objects and sequence objects.
